(19) United States
(12) Patent Application Publication
(10) Pub. No.: US 2026/0328896 A1
(43) Pub. Date: Oct. 22, 2026

(54) Covering Device for a Radar Sensor, Radar Sensor Device, Motor Vehicle, and Method for Producing a Covering Device

(71) Applicant: Bayerische Motoren Werke Aktiengesellschaft, Muenchen (DE)

(72) Inventor: Jonathan ROTH, Muenchen (DE)

(21) Appl. No.: 19/106,789

(22) PCT Filed: Nov. 21, 2023
(86) PCT No.: PCT/EP2023/082455

§ 371 Date: Feb. 26, 2025

(30) Foreign Application Priority Data
Dec. 2, 2022 (DE) 10 2022 131 928.8

(51) Int. Cl. G01S 7/02; G01S 13/931

(52) U.S. Cl. CPC G01S 7/027; G01S 13/931

(57) ABSTRACT

A covering device for a radar sensor includes a decorative layer, which has a first portion having a first index of refraction and a second portion having a second index of refraction, and a support layer on the decorative layer. The support layer has a third portion corresponding to the first portion and having a third index of refraction, and a fourth portion corresponding to the second portion and having a fourth index of refraction. The first portion and the second portion are located next to one another when viewed perpendicularly to a main surface of the decorative layer. The first index of refraction is greater than the second index of refraction, the third index of refraction and the fourth index of refraction are equal, and an average thickness of the third portion is less than an average thickness of the fourth portion.

### BACKGROUND AND SUMMARY

The present invention relates to a covering device for a radar sensor, to a radar sensor device with the covering device and the radar sensor, to a motor vehicle with the covering device or the radar sensor device, and to a method for producing the covering device.

Modern motor vehicles, in particular top-class or luxury cars, regularly comprise various environment sensors for sensing the environment of the motor vehicle. Data obtained by way of these environment sensors may be used by driver assistance systems, for example a light assistance system or an adaptive cruise control system, to assist the driver in operating the motor vehicle. A well-known example of an environment sensor is a (motor-vehicle) radar sensor. This is usually arranged at the front of the motor vehicle, for example in the region of a bumper fascia, and is configured to emit radar waves in the forward direction and to sense radar waves reflected back from objects.

In order to prevent the radar sensor from being damaged by the ingress of moisture, covering it is known from the prior art. For example, the document DE 10 2018 205 739 A1 describes a radar panel having a colored three-dimensional relief, in which three-dimensional structures, of up to one tenth of a radar wavelength, are represented on a front of the protective plate on the basis of design elements in the color of a protective plate material. A chrome look is created on the basis of aluminum or tin.

Against this background, it is an object of the present invention to provide a covering device for a radar sensor that can be produced comparatively efficiently and yet enables a relatively (phase-) homogeneous transmission of the radar waves. Furthermore, it is an object of the invention to provide a corresponding radar sensor device, a corresponding motor vehicle and a corresponding method for producing a covering device.

This object is achieved by a covering device, a radar sensor device, a motor vehicle, and a method for producing a covering device according to the claimed invention.

The covering device is envisaged for a radar sensor, in particular a motor-vehicle radar sensor, and comprises a decorative layer, which has a first portion having a first refractive index and a second portion having a second refractive index, as well as a support layer on the decorative layer. The support layer has a third portion corresponding to the first portion and having a third refractive index, and a fourth portion corresponding to the second portion and having a fourth refractive index. The first portion and the second portion are arranged next to each other as viewed in perpendicular to a main surface of the decorative layer. The first refractive index is greater than the second refractive index. The third refractive index and the fourth refractive index are equal. A mean thickness of the third portion is less than a mean thickness of the fourth portion. An arithmetic mean of the respective thickness may be referred to as the mean thickness (i.e., averaged thickness).

This enables a phase difference, of the first portion relative to the second portion, to be reduced in a simple and effective manner. For radar waves, in this case this phase difference may result from the different phase velocity (vacuum light velocity divided by the respective (frequency-dependent) refractive index) in the first and second portion. For example, when a radar wave propagates through the first and the second portion in the direction of the environment, a phase of the second part of the radar wave propagating through the second part is offset with respect to a phase of the first part of the radar wave propagating through the first part, according to the following equation: Phi=c0*D*[1/n2−1/n1]. Here, Phi denotes the offset between the phases of the first and second part, cO the vacuum light velocity, D the (in this example, identical) thickness of the first and second portion, and n1 and n2 the first and the second refractive index, respectively.

The offset of the phase of the first part of the radar wave with respect to the second part may be at least partially compensated by the lesser mean thickness of the third portion. Thus, the covered radar sensor can provide a high angular resolution. As a result, the radar sensor device with the covering device can be characterized by a high degree of accuracy. Moreover, material can be saved due to the lesser thickness of the third portion. At the same time, optically distinguishable materials having differing refractive indices may be used in the decorative layer to enable a more flexible design of the decorative layer.

In the context of the present disclosure, the refractive index may be understood as a refractive index for radar radiation, in particular for electromagnetic radiation having a frequency of between 20 and 200 GHz, preferably of between 60 and 100 GHz (so-called M-band). The (vacuum) wavelength of the radar waves is thus preferably between approximately 3 mm and 5 mm. Since the third and the fourth refractive index are equal, the same applies to the third refractive index as to the fourth refractive index.

The term “corresponding” in this disclosure, according to its general definition, may mean that the first and the third portion, or the second and the fourth portion, have a relationship to each other. This relationship may be designed in such a way that the first and the third portion overlap as viewed in perpendicular to the main surface. Similarly, the second portion may overlap the fourth portion as viewed in perpendicular to the main surface. Thus, wave fronts propagating through the third portion may also propagate through the first portion, and/or wave fronts propagating through the fourth portion may also propagate through the second portion. Overlapping may mean congruent in each case.

The covering device may have a front side and a rear side. Accordingly, the terms “front side” and “rear side” are also used in the context of the present disclosure. The rear side may be the side facing toward the radar sensor when properly arranged. This means that radar waves emitted by the radar sensor may impinge on the rear side of the covering device, propagate through the covering device in the direction of the front side of the covering device and, after being reflected back at an object to be sensed, propagate through the covering device in the opposite direction, i.e. from the front side in the direction of the rear side. The covering device may thus preferably be referred to as radar-transparent.

It has been said that the support layer is arranged on the decorative layer. In particular, the support layer may be realized (directly or indirectly) on the rear side of the decorative layer. Preferably, the support layer is materially bonded to the decorative layer, such that the third portion is in planar contact with the first portion. Similarly, the fourth portion may be in planar contact with the second portion, in particular without the first portion and the fourth portion overlapping as viewed in perpendicular to the main surface of the decorative layer. Preferably, the first portion and the second portion each extend over the entire thickness of the decorative layer.

The third portion, on its side that is opposite to the decorative layer (i.e. on the rear side), may have a first relief (so-called surface relief) defining a first mid-surface. Similarly, the fourth portion, on its side that is opposite to the decorative layer, may have a second relief defining a second mid-surface. The first relief may be formed-on in the rear-side surface of the support layer, and define the first mid-surface in such a way that it runs parallel to the main surface of the decorative layer. Similarly, the second relief may be formed-on in the rear-side surface of the support layer, and define the second mid-surface in such a way that it likewise runs parallel to the main surface of the decorative layer.

If the second relief is present, it may have a different profile cross-section from the first relief, such that the third and the fourth portion have different mean thicknesses. Preferably, the mean thickness of the third portion is defined by way of the first mid-surface. The mean thickness of the fourth portion may be defined by way of the second mid-surface. In particular, a distance between an end surface of the support layer, that faces toward the decorative layer, and the first mid-surface may correspond to the mean thickness of the third portion, and/or a distance between the end surface of the support layer, that faces toward the decorative layer, and the first mid-surface may correspond to the mean thickness of the fourth portion. In this way, the effective phase velocity in the first and third, or second and fourth portions, can be defined relatively easily in order to achieve a high transmission phase homogeneity.

For example, the first relief may be realized with prisms or cones arranged in a row and/or the second relief with hemispheres arranged in a row. The bases of the prisms, cones or hemispheres are arranged facing toward the decorative layer. The first and/or second relief may alternatively form a diffusing disk. In this example, a first spatial volume occupied by the material of the third portion, between the decorative layer and an enveloping surface of the first relief that faces away from the decorative layer, is less than a second spatial volume occupied by the material of the fourth portion, between the decorative layer and an enveloping surface of the second relief that faces away from the decorative layer. Accordingly, the second mid-surface (assigned to the second relief) may be further away from the front-side end surface of the support layer. As a result, the condition described above between the mean thickness of the third portion and the mean thickness of the fourth portion is fulfilled. The same applies to a variant in which the first portion or the second portion is realized without the first or second relief, respectively. In this case, the mean thickness of the respective portion corresponds to its total thickness.

The third portion may preferably be realized such that an arithmetic refractive-index mean value of the first and third portion, weighted by the thickness of the first portion and the mean thickness of the third portion, corresponds substantially (preferably with a deviation of up to 10%) to an arithmetic refractive-index mean value of the second and fourth portion, weighted by the thickness of the second portion and the mean thickness of the fourth portion. Alternatively, the following relationship (between the thicknesses and the refractive indices of the aforementioned portions) may apply to increase the phase homogeneity:

D*(1/n2−1/n2)=D2/n3−D1/n3

Here, D denotes the thickness of the decorative layer, n1 to n3 the refractive indices of the first to third portion, D1 the mean thickness of the third portion, and D2 the mean thickness of the fourth portion. In this way, therefore, a phase jump caused by the different phase velocity in the first and second portion may be reduced (i.e. at least partially compensated) by a lesser mean thickness of the third portion.

The total thickness of the covering device (measured through the first and third portion or the second and fourth portion) is preferably at most 10 mm, most preferably at most 5 mm. Preferably, the first and the second portion are (substantially) of the same thickness. This can be achieved in particular by way of a decorative layer, which is realized as an imprint, in particular a screen print, on a film. The support layer is preferably thicker and more stable, in particular stiffer, than the decorative layer and may impart stability to the covering device. Preferably, the support layer is between 1.5 mm and 8 mm thick. The mean thickness of the third portion in this case may be at most 6 mm. A first relief height of the first relief and/or a second relief height of the second relief may each be less than the wavelength of the radar wave, and may preferably be at most 200 μm, in particular between 50 μm and 150 μm. Here, a distance between the lowest point of the relief here and the respective enveloping surface is referred to as the relief height. To make it easier to define the phase compensation by way of the first and second relief, the first relief height and the second relief height may be substantially equal.

A covering device having these features can be produced comparatively easily by way of injection molding. In particular, the support layer may be easily molded onto the film, in particular onto the decorative layer (i.e. the decorative layer is back-injected with the material of the support layer). Preferably, the support layer is thus realized monolithically (without joints/“from a single casting”). Accordingly, the third and the fourth portion are preferably produced from the same material. The support layer, the film and/or the top layer described in more detail below are each preferably produced from a polymer, in particular polycarbonate (PC) or polymethyl methacrylate (PMMA). The top layer may alternatively be produced from polyurethane. In this case, the top layer can be made thinner. The support layer, the film and/or the top layer may each be translucent, in particular transparent, preferably optically clear. In particular in the radar frequency spectrum, the first refractive index and/or the second refractive index may each be greater than the third refractive index. The third refractive index may be between 1.6 and 1.7, preferably between 1.65 and 1.7.

The covering device may additionally comprise a heating layer and/or a top layer. The heating layer may be produced from the same base material as the support layer. Advantageously, this base material together with the support layer may be molded onto the film with the decorative layer (preferably by way of injection molding). The entirety of the base material of the heating layer, film, decorative layer and support layer can thus be produced rapidly and cost-effectively in a single injection molding operation, in which the film with the decorative layer serves as an insert. The heating layer preferably comprises an apparatus for electrically heating the covering device. Such an apparatus would preferably be a heating wire that is embedded, at least in some sections, in the base material. The heating wire is preferably less than 2 mm thick. In this way, a high degree of transmission phase homogeneity may be achieved with, at the same time, efficient heating and high degree of tightness of the covering device.

The top layer is preferably arranged on a side of the decorative layer that is opposite to the support layer and/or possibly on a side of the heating layer that is opposite to the support layer. If present, the top layer realizes an end surface of the covering device. When the covering device is in the installed position in the radar sensor device, or on the motor vehicle, the end surface is an outer surface of the covering device/radar sensor device, via which radar waves generated by the radar sensor can exit into the environment.

The optical characteristics of the covering device are described in more detail below. An optically visible pattern of the covering device may be limited to the decorative layer. In particular, the first portion (of the decorative layer) may be optically different (contrasting) from the second portion. For example, the first portion of the decorative layer may realize a pattern that is optically distinguishable from the second portion. The difference may be designed, for example, in respect of color, based on a degree of transparency (e.g. transparent, translucent or opaque) or as a reflection.

The first portion and/or the second portion may also each comprise a plurality of sub-portions, each of which realizes a (predefined, static) pattern. In this case, for the purpose of local phase compensation, the third portion may likewise comprise a plurality sub-portions, which, as viewed in perpendicular to the main surface of the decorative layer, overlap the sub-portions of the first portion, in particular are congruent with it. This applies analogously to the relationship between the fourth portion and the second portion.

In a preferred variant, the decorative layer is backlit by way of the support layer. For this purpose, the support layer may be realized as a light conducting layer and, in particular, form a so-called light-guide sheet. The support layer may be configured to guide coupled-in light in the interior (and in the material) of the light conducting layer (preferably with total internal reflection) at a coupling-in point spaced apart from the third and/or fourth portion. This light may be generated by way of an electrically operated light source that has at least one illuminant (for example a light-emitting diode or a laser diode) of the covering device. In order to couple the light out of the support layer/light conducting layer, the support layer may have a light coupling-out structure in the third and/or fourth portion. In particular, the light coupling-out structure may be designed to at least partially couple out, in the direction of the decorative layer/front side of the covering device, the light propagating in the support layer. In principle, the coupling-out structure may be realized to be light-scattering, reflective or light-refracting in order to couple out the light. In a preferred variant, the light coupling-out structure comprises the first and/or second relief. The first/second relief may thus provide a hybrid function in a synergistic manner, namely phase equalization for the radar wave and coupling-out of the light.

The radar sensor device proposed here is envisaged for a motor vehicle, in particular a ground, floor or water vehicle, preferably for a passenger car or a commercial vehicle. The motor vehicle may be an at least partially electrically powered (an electro-hybrid or fully electric) vehicle. The radar sensor device comprises a covering device, described in detail above, a housing that defines an inner region of the radar sensor device, and a radar sensor covered by way of the covering device. The radar sensor may also be the radar sensor described above. The covering device delimits the inner region, and the radar sensor is arranged, at least in some sections, in the inner region.

If the support layer is designed to conduct light, the outer surface may form a light-exit surface. Properly, the radar sensor is arranged on the rear side of the covering device. In particular, the radar sensor may emit radar waves in such a way that they propagate at least partially through the first and the second portion and, parallel thereto, through the third and the fourth portion. In other words, the first, second, third and/or fourth portion may be arranged in the sensing range of the radar sensor.

In a variant, the radar sensor may protrude, on a side opposite to the covering device, from the housing. The radar sensor may comprise its own sensor housing. In this way, the radar sensor device can be highly efficient in respect of installation space. Advantageously, this can provide better cooling of the radar sensor. In addition, the radar sensor device may have a funnel-shaped shielding. In a variant, this shielding may narrow from the housing in the direction of the radar sensor. Accordingly, the shielding preferably forms a funnel that absorbs radar waves. A surface of this shielding that faces toward the covering device may preferably be realized as an injection-molded absorber, in particular of expanded polypropylene (EPP). In a further variant, the radar sensor may be integrated in the covering device, in particular over-molded with material of the covering device.

The motor vehicle proposed here comprises the covering device described in detail above or the radar sensor device described in detail above. Preferably, the covering device forms an end-face end surface of the motor vehicle that is exposed to airstream during travel.

In the method proposed here, a covering device as described above is produced by at least one injection molding operation, the injection molding operation comprising at least the following steps, which are preferably performed in the sequence described below: inserting an insert, comprising the decorative layer, into an injection mould; injecting a molding compound for the support layer into a cavity of the injection mould, wherein the support layer is formed onto the insert. In particular, the insert may comprise the decorative layer on the film.

The support layer may preferably be molded directly onto the decorative layer. Most preferably, the step of injecting the molding compound comprises realizing the support layer, as well as realizing a layer with base material of the heating layer on a side of the decorative layer that is opposite to the support layer. Thus, after the support layer has been formed onto the insert, the heating wire may be embedded into the base material by way of a sonotrode, at least in some sections, in order to realize the finished heating layer. This makes it possible to dispense with expensive heating foils, which are comparatively expensive.

In a further step, the top layer may then be realized on the front side, directly on the heating layer or (in the absence of a heating layer) directly on the decorative layer. This step may be performed by way of reactive injection molding, and may preferably comprise the following steps, which in particular may be performed in the following order: removing a first mould cover of the injection mould following the injection compression molding operation; attaching a second mould cover of the injection mould; flooding the cavity of the injection mould with a second molding compound in order to form the top layer, the second molding compound comprising two (or more) components. In order to form the top layer of polyurethane, the second molding composition may comprise corresponding polyols and polyisocyanates.

Both the radar sensor device and the motor vehicle, and the method, may comprise any, in particular all, of the features described above in connection with the covering device.

Preferred variants of a covering device, a radar sensor device, a motor vehicle and a method for producing a covering device are now explained in more detail with reference to the accompanying schematic drawings.

### BRIEF DESCRIPTION OF THE DRAWINGS

FIG. 1 shows a variant of a covering device in a cross-sectional view.

FIG. 2 shows the variant from FIG. 1 in a detailed cross-sectional view, with the first, second, third and fourth portions represented in enlarged form.

FIG. 3 shows a further variant of a covering device in a cross-sectional view, there being a second relief realized on the fourth portion.

FIG. 4 shows the variant from FIG. 3 in a detailed cross-sectional view, with the first, second, third and fourth portions represented in enlarged form.

FIG. 5 shows a further variant of a covering device in a cross-sectional view, the first portion realized in multiple parts.

FIG. 6 shows a variant of a radar sensor device.

FIG. 7 shows a further variant of a radar sensor device.

FIG. 8 shows a motor vehicle with the radar sensor device.

FIGS. 9a-9c show intermediate states of the production of the covering device of FIG. 1.

FIG. 10 shows a method for the production of the covering device of FIG. 1.

### DETAILED DESCRIPTION OF THE DRAWINGS

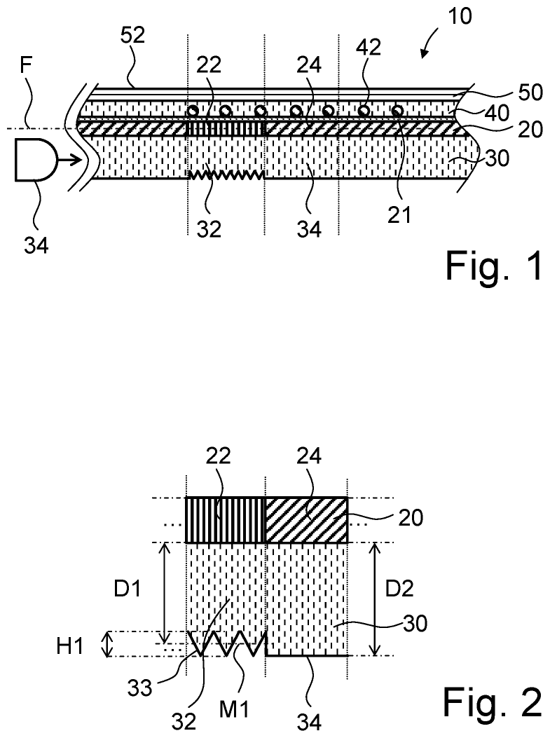

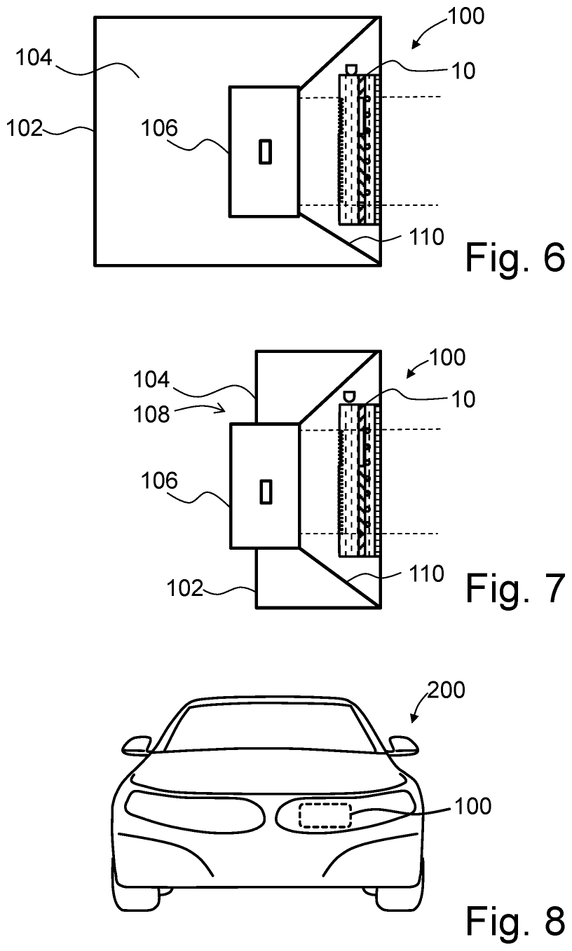

FIGS. 1 and 2 show a covering device 10 for a radar sensor 106 shown schematically in FIG. 6. The radar sensor 106 is realized as a motor-vehicle radar sensor and is envisaged for use in the motor vehicle 200, shown in simplified form in FIG. 8, which is a passenger car. The covering device 10 has a rear side, which in FIG. 1 is represented at the bottom, and a front side, which in FIG. 1 is represented at the top. When properly mounted, the rear side is arranged facing toward the radar sensor 106 (see FIG. 6).

The covering device 10 comprises a decorative layer 20, and a support layer 30 that is realized on the rear side of the decorative layer 20. In the variant shown in FIG. 1, the support layer 30 is formed directly onto the rear side of the decorative layer 20. The decorative layer 20 is provided as a screen print on a film 21 and comprises a first portion 22, which is optically distinguishable from a second portion 24. In the present case, the first portion 22 is, for example, darker than the second portion 24. The first portion 22 may be translucent; at least the second portion 24 is translucent. The first portion 22 has a first refractive index for a predefined (radar) frequency of electromagnetic radiation, and the second portion 24 has a second refractive index for the predefined frequency of the electromagnetic radiation. The predefined frequency is an operating frequency of the radar sensor 106. In the present case, for example, this frequency is between 70 and 80 GHz.

As viewed in perpendicular to the main surface F of the decorative layer 20, a third portion 32 of the support layer 30 overlaps the first portion 22 completely, preferably in particular substantially congruently. Similarly, a fourth portion 34 of the support layer 30 overlaps the second portion 24 completely, preferably in particular substantially congruently. Thus, the third portion 32 corresponds to the first portion 22, and the fourth portion 34 corresponds to the second portion 24. As additionally shown in FIG. 1, the first portion 22 and the second portion 24 are arranged next to each other, as viewed in perpendicular to the main surface F, without substantially overlapping each other. This applies analogously to the third portion 32 and the fourth portion 34.

The third portion 32 has a third refractive index for the predefined frequency, and the fourth portion 34 has a fourth portion for the predefined frequency. The following applies to the first to the fourth refractive index for the predefined frequency. While the third refractive index and the fourth refractive index are equal, the first refractive index is greater than the second refractive index. This means that the covering device 10 allows the use of colorants having differing refractive indices for radar waves. This is made possible by the fact that a mean thickness D1 of the third portion 32 is less than a mean thickness D2 of the fourth portion 34. Accordingly, phase jumps produced by the decorative layer 20 are equalized by differing mean thicknesses D1, D2, to increase the phase homogeneity. In the present case, the support layer 30, in particular the third portion 32 and the fourth portion 34, are produced from polycarbonate, in particular clear polycarbonate, molded onto the decorative layer 20. The third and the fourth refractive index are therefore 1.67. The film 21 is also produced from polycarbonate, and in this case is translucent, in particular transparent. An arithmetically averaged refractive index along an axis through the first and the third portion 22, 32, weighted on the basis of the respective thicknesses, may correspond to an arithmetically averaged refractive index along an axis through the second and the fourth portion 24, 34, likewise weighted on the basis of the respective thicknesses.

In the variant shown in FIG. 1, the fourth portion 34 has a substantially constant thickness across its width, which thus corresponds to the mean thickness D2. The third portion 32, on the other hand, has, on its side that is opposite to the decorative layer 20, a first relief 33 that defines an averaged first mid-surface M1. The mean thickness D1 of the third portion 32 is thus, as indicated in FIG. 2, a distance between the interface of the first portion 22 to the third portion 32 and the first mid-surface M1. A height H1 of the first relief 33 is preferably between 50 μm and 200 μm, for example 100 μm. The first relief 33 is composed of a plurality of prisms, which realize a light coupling-out structure and therefore enable light propagating in the support layer 30, realized as a transparent light conducting layer, to be deflected in the direction of the decorative layer 20. This light is coupled out from the support layer 30. To generate and couple the light into the support layer 30, the covering device 10 comprises a light source 34.

The design of the covering device 10 as shown in FIGS. 1 and 2 can enable a phase difference of more than 3°, caused by the first and the second portion 22, 24, to be compensated. The following example calculation for the spatial volume occupied by the first relief 33, of the height H1 (up to the enveloping surface), and a corresponding spatial volume of the same height completely occupied by the material of the fourth portion 34 illustrates this phase compensation. With the first height H1 of 100 μm, the refractive index of polycarbonate (1.67) and a vacuum wavelength of 3.9 mm, a phase jump of 15.4° is calculated for the spatial volume of height H1 in the region of the fourth portion. In the spatial volume of the height of the first relief 33 in the region of the third portion, the phase jump is 12.3° (due to only half of this spatial volume being filled with polycarbonate, an averaged refractive index of (1.67+1)/2=1.33 is assumed). The part of a radar wave propagating through the third portion is thus offset in phase by approximately 3° compared to a part of the radar wave propagating parallel to it through the fourth portion. The calculation of the (effective) refractive index of the spatial region may be effected on the basis of the volume ratios of the two materials (in this case polycarbonate and air).

On the front side relative to the support layer 30, the covering device 10 has a heating layer 40, in which a heating wire 42 is embedded at least in some sections, and a top layer 50, which realizes an end surface 52 of the covering device 10. The light from the support layer 30 exits the covering device 10 at the front side through the end surface 52, such that the end surface 52 may be referred to as the light exit surface. The material of the heating layer 40 may be realized as a single piece, in particular as a single material (monolithic), with the support layer 30. The base material is thus preferably the same material as the material of the support layer 30, i.e. polycarbonate in this example. A covering device 10 having these features can be produced comparatively inexpensively by over-molding the decorative layer 20 and subsequently embedding the heating wire 42 (if necessary, before the top layer 50 is produced) into the base material of the heating layer 40. The top layer 50 may in principle also be made of the same material as the support layer 30. Preferably, however, the top layer 52 is made of polyurethane, which is formed onto the finished heating layer 40 in a reactive injection molding process.

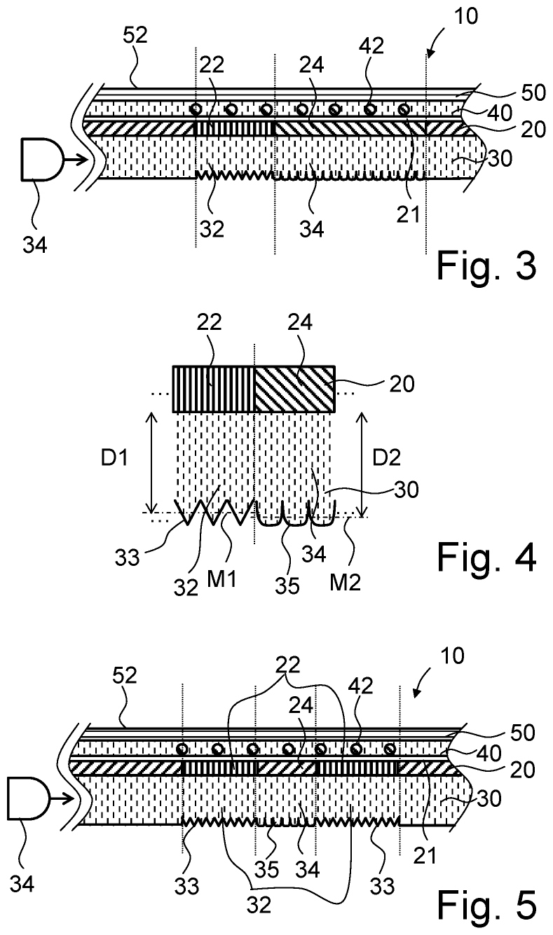

A further covering device 10, shown in FIGS. 3 and 4, differs from the covering device 10 of FIG. 1 in that the fourth portion 34 has, on its side that is opposite to the decorative layer 20, a second relief 35 defining a second mid-surface M2. The mean thickness D2 of the fourth portion 34 is defined by way of the second mid-surface M2, i.e. a distance between the end surface of the support layer 30 that faces toward the decorative layer 20 and the second mid-surface M2 corresponds to the mean thickness D2. The second relief 35 has a different cross-sectional profile from the first relief 33. In the present case, the cross-sectional profile of the first relief 33 is realized as a (zigzag) profile having V-shaped serrations arranged in a row, and the cross-sectional profile of the second relief 35 is realized as a profile having U-shaped portions arranged in a row. This difference has an effect on the third and the fourth portion 32, 34 in that the second mid-surface M2 is spaced further from the interface between the second and the fourth portion 24, 34 than the first mid-surface M1 is from the interface between the first and the third portion 22, 32.

The second relief 34 makes it possible to compensate a phase jump produced by the second portion 24. Accordingly, a second refractive index of the second portion 24 is less than the first refractive index 22 and greater than a refractive index/or refractive indices of the rest of the decorative layer 20. In this variant, the light coupling-out structure of the support layer 30 comprises the first and the second relief 33, 35. In addition, the covering device 10 of FIGS. 3 and 4 includes all the features of the covering device 10 of FIGS. 1 and 2.

A further covering device 10, shown in FIG. 5, differs from the covering device 10 of FIG. 3 in that the first portion 22 comprises a plurality of regions (so-called sub-portions). These regions may together form a pattern that is optically different from the second portion. Consequently, the first relief 33 also comprises a plurality of regions corresponding to the regions of the first portion 22. In the variant shown in FIG. 5, at least two such regions of the first portion 22, and of the first relief 33, are separated from each other by the second portion 24, and the fourth portion 34, respectively. In addition, the covering device 10 of FIG. 5 includes all the features of the covering device 10 of FIGS. 3 and 4.

FIGS. 6 and 7 show various radar sensor devices 100 for the motor vehicle 200. Each of the radar sensor devices 100 has the covering device 10 of FIG. 1 (alternatively one of the other covering devices 10 described above), a housing 102, and the radar sensor 106 to be covered. The housing 102 defines an inner region 104 of the radar sensor device 100, the inner region being delimited in both variants by way of the covering device 10. In the variant shown in FIG. 6, the radar sensor 106 is arranged completely in the inner region 104 (i.e. de facto encapsulated in the housing). In the variant shown in FIG. 7, the radar sensor 106, in particular a radar sensor housing of the radar sensor 106, protrudes from the rear side of the housing 102 of the radar sensor device 100. This can provide better cooling of the radar sensor 106. Between the radar sensor 106 and a side of the housing 102 on which the covering device 10 is realized, the radar sensor device 100 may also have a funnel-shaped, radar-absorbing shielding 110, which narrows from the housing 102 in the direction of the radar sensor 106.

The motor vehicle 200 represented in FIG. 8 comprises the covering device 10 of FIG. 1, 3 or 5, preferably as part of the radar sensor device 100 of FIG. 6 or 7, and the covering device 10 may be realized as a portion of a front light 202 of the motor vehicle 200. Accordingly, the covering device 10 is designed to emit light, coupled into the support layer 30 by way of the light source 34, at least partially in the longitudinal direction of the vehicle.

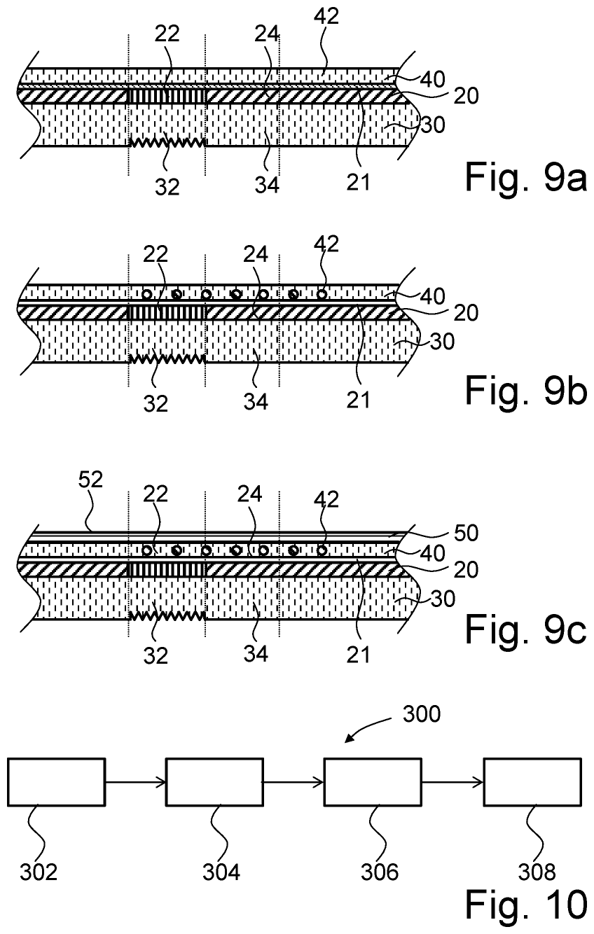

A method 300 represented schematically in FIG. 10 is used for the production of the covering device 10 of FIG. 1. The method 300 may be performed analogously to produce the covering device 10 of FIG. 3 or FIG. 5. The method 300 comprises at least one injection molding operation in which, in a first step 302, an insert comprising the decorative layer 20 is inserted into an injection mould. Then, in step 304, a molding compound for the support layer 30 is injected into a cavity of the injection mould, the support layer 30 being formed onto the insert. This results in an intermediate product of the covering device 10, shown in FIG. 9a, without the heating wire 42 and without the top layer 50.

In a further step 306, the heating wire 42 may be embedded by way of a sonotrode into the base material of the heating layer 40 already realized in step 304, in order to complete the heating layer 40 (see FIG. 9b). The intermediate product shown in FIG. 9b may then be realized, in a further step 308, by reactive injection molding of the top layer 50 onto the heating layer 40. Here, the injection mould provided for injection molding may be flooded with the reaction partners provided for the formation of polyurethane.

The terms “comprising”, “having”, “with” and the like used in this disclosure are to be understood as non-exhaustive. In particular, the term “comprising a(n)” in this context means “comprising at least one”, i.e. “comprising a(n)” does not exclude the presence of further corresponding elements. For example, the terms “comprising a support layer”, “comprising a light source” and “comprising a first portion” are to be understood such that the covering device may have one or more support layers, as well as one or more light sources, and the decorative layer may have one or more first portions. The above mathematical relationships, or equations, are deemed to be fulfilled if deviations therefrom do not exceed production tolerances. The term “substantially” may be understood as within the scope of usual production tolerances (+/−10% of the respective value).

1.-12. (canceled).

13. A covering device for a radar sensor, the covering device comprising:
a decorative layer, which has a first portion having a first refractive index and a second portion having a second refractive index; and
a support layer on the decorative layer,
wherein the support layer has a third portion corresponding to the first portion and having a third refractive index, and a fourth portion corresponding to the second portion and having a fourth refractive index,
wherein the first portion and the second portion are arranged next to each other as viewed in perpendicular to a main surface of the decorative layer,
wherein the first refractive index is greater than the second refractive index,
wherein the third refractive index and the fourth refractive index are equal, and
wherein a mean thickness of the third portion is less than a mean thickness of the fourth portion.

14. The covering device according to claim 13,
wherein the third portion, on its side that is opposite to the decorative layer, has a first relief defining a first mid-surface, and the mean thickness of the third portion is defined by way of the first mid-surface, and/or
wherein the fourth portion, on its side that is opposite to the decorative layer, has a second relief defining a second mid-surface, and the mean thickness of the fourth portion is defined by way of the second mid-surface.

15. The covering device according to claim 13,
wherein the first refractive index and/or the second refractive index are each greater than the third refractive index, and/or
wherein the third refractive index is between 1.6 and 1.7.

16. The covering device according to claim 13,
wherein the decorative layer is realized as a screen print on a film, and/or
wherein the support layer is molded onto the decorative layer, and/or
wherein the third portion and the fourth portion are produced from a same material.

17. The covering device according to claim 13, further comprising:
a heating layer, in which a heating wire is embedded, at least in some sections; and/or
a top layer on a side of the decorative layer that is opposite to the support layer, wherein the top layer realizes an end surface of the covering device.

18. The covering device according to claim 13,
wherein the first portion is optically different from the second portion, and/or
wherein the decorative layer is translucent, at least in some sections, and/or
wherein the support layer is translucent, at least in some sections.

19. The covering device according to claim 13,
wherein the support layer is realized as a light conducting layer, and/or
wherein the support layer has, in the third portion and/or the fourth portion, a light coupling-out structure that is configured to at least partially couple out, in a direction of the decorative layer, light propagating in the support layer.

20. The covering device according to claim 19,
wherein the third portion, on its side that is opposite to the decorative layer, has a first relief defining a first mid-surface, and the mean thickness of the third portion is defined by way of the first mid-surface, and/or
wherein the fourth portion, on its side that is opposite to the decorative layer, has a second relief defining a second mid-surface, and the mean thickness of the fourth portion is defined by way of the second mid-surface, and
wherein the light coupling-out structure comprises the first relief and/or the second relief.

21. A radar sensor device for a motor vehicle, the radar sensor device comprising:
the covering device according to claim 13;
a housing that defines an inner region of the radar sensor device; and
a radar sensor covered by the covering device,
wherein the covering device delimits the inner region, and
wherein the radar sensor is arranged, at least in some sections, in the inner region.

22. The radar sensor device according to claim 21,
wherein the radar sensor protrudes, on a side that is opposite to the covering device, from the housing, and/or
wherein the radar sensor device further comprises a funnel-shaped shielding, which narrows from the housing in a direction of the radar sensor.

23. A motor vehicle comprising the covering device according to claim 13.

24. A motor vehicle comprising the radar sensor device of claim 21.

25. A method for producing the covering device according to claim 13, the method comprising at least one injection molding operation comprising:
inserting an insert comprising the decorative layer, into an injection mold; and
injecting a molding compound for the support layer into a cavity of the of the injection mold, wherein the support layer is formed onto the insert.
